(19) United States
(12) Patent Application Publication
(10) Pub. No.: US 2013/0311207 A1
(43) Pub. Date: Nov. 21, 2013

(54) Medical Record Processing

(71) Applicants: Richard D. Kemp, Edgewater, NJ (US); Sam Jensen, Larchmont, NY (US)

(72) Inventors: Richard D. Kemp, Edgewater, NJ (US); Sam Jensen, Larchmont, NY (US)

(73) Assignee: INNODATA SYNODEX, LLC, Hackensack, NJ (US)

(21) Appl. No.: 13/474,222

(22) Filed: May 17, 2012

(51) Int. Cl. G06F 17/30; G06Q 40/08

(52) U.S. Cl. 705/4; 707/736; 707/E17.01

(57) ABSTRACT

Systems, apparatus, and methods for medical record processing are provided. Medical record processing may be implemented by performing data-point analysis on a medical file to generate a data-point file. The data-point file is automatically coded to generate a coded file. The medical file may be preprocessed prior to performing data-point analysis, and non-relevant information may be removed from the medical file. Data-point analysis may be performed based on a predefined data-point specification.

### TECHNICAL FIELD

The present disclosure is generally directed to processing medical records, and more specifically to processing medical records for input to an automated process.

### BACKGROUND

Collecting useful data from medical records is often tedious. Medical records related to a particular individual are often stored at disparate locations. Once these records are located, the task of gathering and analyzing the records is often labor-intensive. Typically, records must be organized and mined for data. Further, if the data is being gathered for input to an automated process, such as an automated insurance underwriting process, the records may also need to be formatted.

While current methods of processing medical records for automated processes can be useful, these methods are often informal and disorganized. Processing errors and other abnormalities often occur, which may cause automated processes that utilize the records to be inaccurate. At the very least, such inaccuracies can cause delays to automated processes when they are discovered.

### SUMMARY

Systems, apparatuses, and methods for processing medical records are provided. In accordance with an embodiment, a method for processing medical records includes performing data-point analysis on a medical file to generate a data-point file. The data-point file is automatically coded to generate a coded file. The medical file may be preprocessed prior to performing data-point analysis, and non-relevant information may be removed from the medical file. Data-point analysis may be performed based on a predefined data-point specification.

In accordance with an embodiment, the coded file may be normalized to generate a medical report, and the data-point file may be automatically coded based at least in part on feedback from a prior normalization. The medical report may be provided to an automated insurance underwriting process.

In accordance with an embodiment, the data-point file may comprise a plurality of data-points and the data-point file may be automatically coded by assigning one or more MeSH, MIB, ICD-10 or ICD-10-CM codes to the data-points. Data-point analysis may be performed to identify probable errors in the data-point file, and the coded file may be provided to an automated insurance underwriting process.

In accordance with an embodiment, a correlation may be determined between the coded file and other mortality or life expectancy data, and the correlation may be provided to the automated insurance underwriting process, wherein a life expectancy is predictable based on the correlation. The correlation may be used to determine whether a person is insurable in a ratable class of insurability or is uninsurable.

In accordance with an embodiment, a heat map of individual or group medical conditions, disease or symptoms may be generated based on a plurality of coded files, and the heat map may be provided to the automated insurance underwriting process.

In accordance with an embodiment, a correlation may be determined based on reported individual or group symptoms or medical test results, and the correlation may be provided to the automated insurance underwriting process, wherein a future disease trend is predictable based on the correlation.

These and other advantages of the invention will be apparent to those of ordinary skill in the art by reference to the following detailed description and the accompanying drawings.

### BRIEF DESCRIPTION OF THE DRAWINGS

FIG. 1A is a flowchart of a process for medical record processing in accordance with an embodiment;

FIG. 1B illustrates a heat map based on one or more coded files in accordance with an embodiment;

FIG. 2 is a workflow diagram showing an environment that may be used for processing medical records in accordance with an embodiment;

FIG. 3A illustrates a page of a medical file in accordance with an embodiment;

FIG. 3B illustrates another page of a medical file in accordance with an embodiment;

FIG. 4 illustrates a data-point file in accordance with an embodiment;

FIG. 5 illustrates a preliminary classification of a particular data point of a data-point file in accordance with an embodiment;

FIG. 6 illustrates a coded file in accordance with an embodiment; and

FIG. 7 is a high-level block diagram of an exemplary computer that may be used for implementing medical record processing.

### DETAILED DESCRIPTION

In accordance with the various embodiments, medical record processing as disclosed herein includes generating a medical report with data from an individual's medical records. Relevant data from medical record files is first extracted and then normalized based on standardized codes (e.g., ICD-10-CM disease and ICD-10-PCS procedure codes) or synthetic codes based on multiple variables (e.g., combinations of medical conditions, pain scales or measurements). The generated medical report then may be formatted for input to an automated insurance underwriting process. The various embodiments support electronic data record processing for life, health and disability insurance underwriting processes. Moreover, the embodiments provide medical reports including normalized categories and formats that can be integrated with other medical record analyses and predictive models, including models for predicting disease trends.

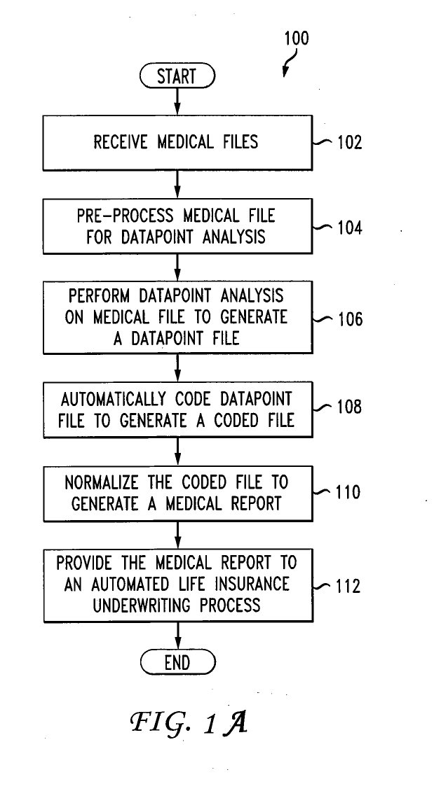

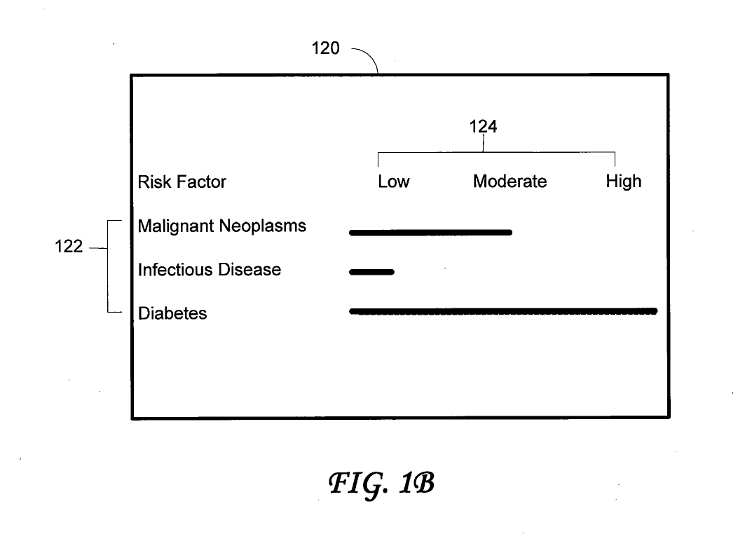

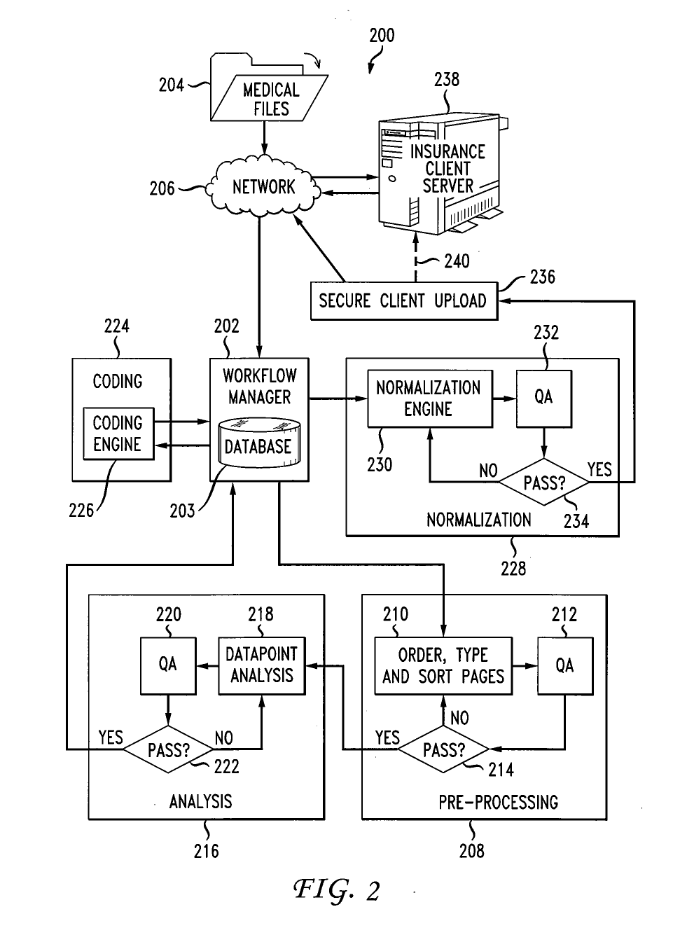

FIG. 1A is a flowchart of a process for medical record processing in accordance with an embodiment. Process 100 presents a summary of the methods employed for medical record processing, as detailed in the work flowchart of FIG. 2. In process 100, data point analysis is performed on a medical file to generate a data-point file, the data-point file is automatically coded to generate a coded file and the coded file is normalized to generate a medical report. For example, a medical file is received at a workflow manager at 102. At 104, the medical file is pre-processed for data-point analysis. For example, pre-processing may include removing non-relevant information from the medical file, such as regulatory or personal information. At 106, data point analysis is performed on the medical file to generate a data-point file. In one embodiment, data point analysis may be performed based on a predefined data point specification. For example, the data point specification may be based on one or more coding standards such as MeSH, MIB, ICD-10 or ICD-10-CM. Performing data point analysis also may include identifying probable errors in the medical file (e.g., clearly erroneous notations of diagnoses or prescribed medications), and correcting such erroneous data.

The data-point file is automatically coded to generate a coded file at 108. For example, the data-point file may comprise a plurality of data-points and automatically coding the data-point file (e.g., via a coding engine) may comprise assigning one or more MeSH, MIB, ICD-10 or ICD-10-CM codes or, alternatively, synthetic codes to the data-points. At 110, the coded file is normalized to generate a medical report. In one embodiment, the automatic coding at 108 may be based at least in part on feedback from one or more prior normalizations.

At 112, the medical report is provided to an automated insurance underwriting process, such as via a secure client upload (e.g., either via a network or a direct connection). In one embodiment, a correlation may be determined between the coded file and mortality or life expectancy data, and the correlation may be provided to the automated insurance underwriting process (e.g., along with the medical report). For example, a life expectancy prediction may be determined based on the correlation.

In another embodiment, a correlation may be determined between the coded file and reported individual or group symptoms or medical test results. The correlation may then be provided to the automated insurance underwriting process for predicting future disease trends. FIG. 1B illustrates a heat map based on one or more coded files in accordance with an embodiment. For example, a heat map 120 of individual or group medical conditions, diseases or symptoms may be generated based on a plurality of coded files provided to the automated insurance underwriting process. A heat map 120 of individual or group medical conditions may include a list or graphical representation of critical or important medical conditions that determine insurability. The list or graphical representation may be grouped by type of disease 122 or other risk factors. For example, a heat map may include color codes or other indications to represent relative risk in different medical groups. In one embodiment, one or more normalized data sources may be used to determine the classifications 124 (e.g., low, moderate, high) underlying the list or graphical representation.

FIG. 2 is a workflow diagram showing an environment for processing medical records in accordance with an embodiment. In environment 200, workflow manager 202 is configured to manage and/or store (via database 203) one or more medical record files 204 (also referred to herein as medical files) received via network 206. For example, network 206 may be a private network (e.g., a company or healthcare provider intranet), a public network (e.g., the public Internet) supporting secure transmissions of machine-readable or imaged (e.g., PDF format) medical files or, alternatively, a combination of networks.

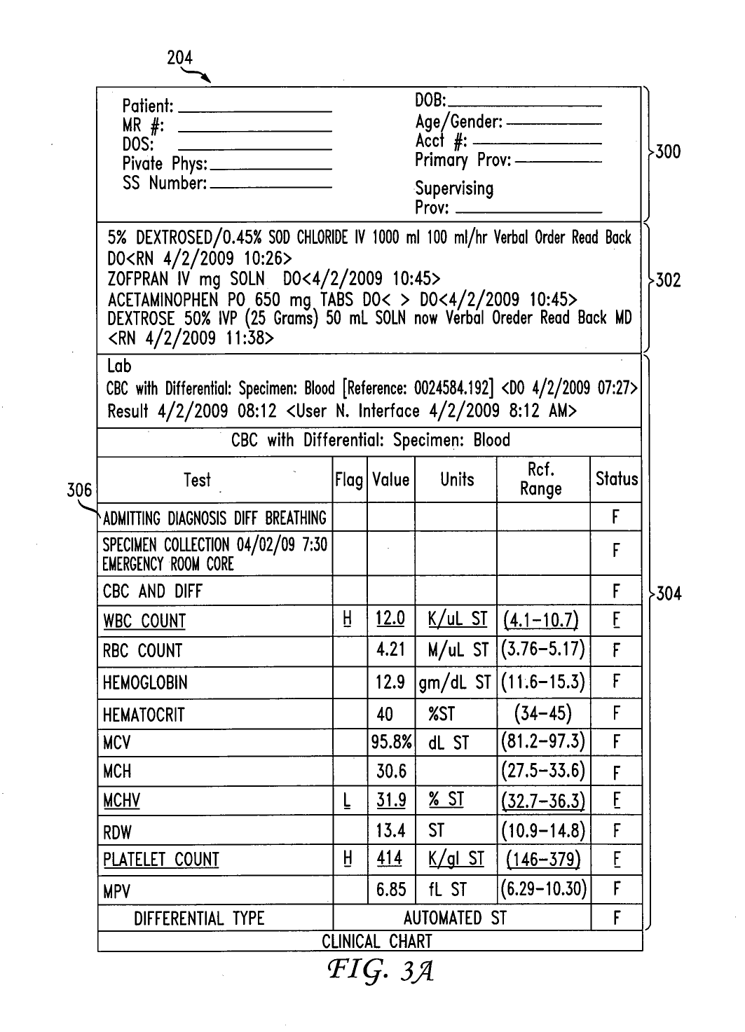

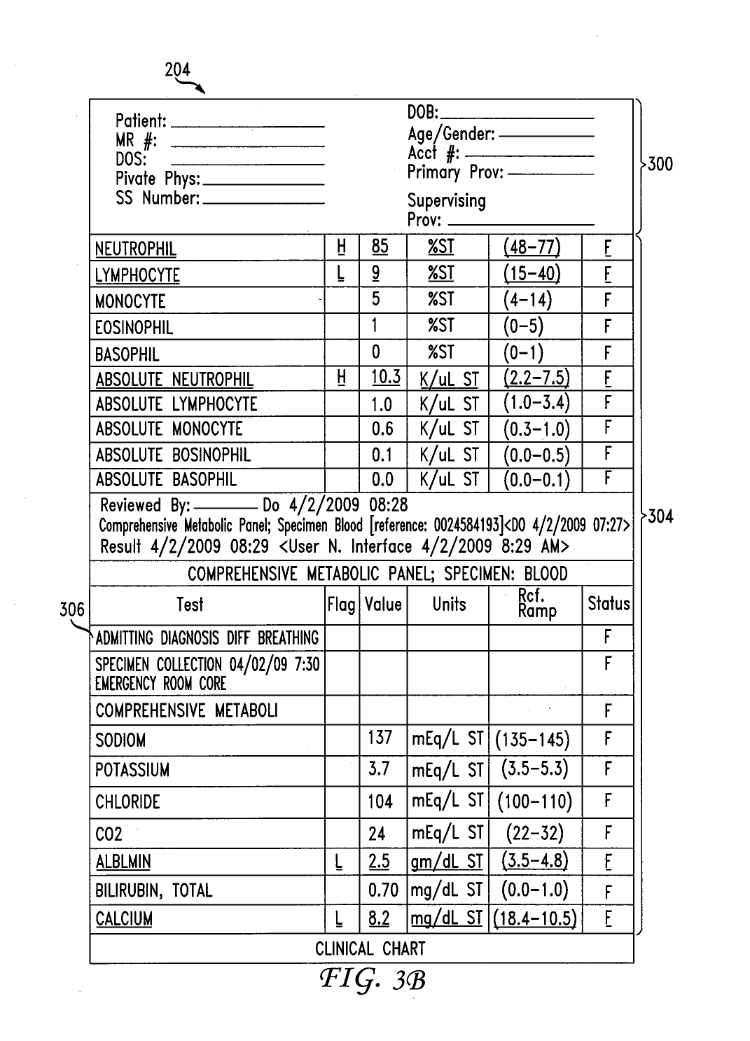

In one embodiment, medical files 204 may include raw data that can be processed to generate formatted medical reports, including medical reports that are useful for automated life, health or disability insurance underwriting processes. FIGS. 3A and 3B illustrate pages of a medical file in accordance with an embodiment. For example, medical file 204 may contain patient information 300, including address and billing information for an individual. Medical file 204 may also contain data associated with doctor visits including, treatments and prescribed medications 302, test results 304, diagnoses 306, and other data. A medical file 204 also may contain additional information, such as regulatory, administrative or general medical data.

Workflow manager 202 coordinates steps for processing a medical file 204 to generate a medical report. In one embodiment, workflow manager 202 coordinates the pre-processing of a medical file 204 by providing medical file 204 (e.g., a medical file stored in database 203) to pre-processing function 208. In pre-processing function 208, the medical file 204 is ordered (e.g., organized and/or classified), typed and/or sorted 210 for subsequent processing steps. For example, ordering, typing or sorting operations 210 for a medical file may include converting data (e.g., from machine-readable to human-readable formats, or vice versa), matching data with a particular individual or a plurality of individuals, and extracting data (e.g., regulatory or boilerplate sections) that is not relevant to subsequent processing.

Operations within pre-processing object 208 may be implemented automatically (e.g., by a machine), semi-automatically or manually. For example, at a remote location one or more humans (e.g., utilizing remote access terminals in communication with workflow manager 202 and database 203) may order, type or sort or otherwise pre-process a medical file 204. Moreover, additional personnel at the remote location (or at another location) may perform operations for quality assurance (QA) 212. For example, if a pre-processed medical file does not comply with QA standards, the file may be returned for additional ordering, typing or sorting operations, including error correction, at 214. In one embodiment, QA 212 is managed by comparing data entries to machine made classifications of disease based on, for example, a semantic analysis of expressions in text and expected relevancy to specific disease classifications. For example, for a text entry “moderate aortic stenosis”, machine analysis can rank the best probably match of the text entry to a code (e.g., “I35.0 Aortic (valve) stenosis”) based on one or more databases of relevancy rules.

If the pre-processed file is determined to be in compliance with QA standards, the pre-processed file is provided to analysis function 216 for data-point analysis. In one embodiment, the pre-processed file may be provided to analysis function 216 directly from the preprocessing location. Alternatively, the pre-processed file may be received by workflow manager 202 after preprocessing and then provided by workflow manager 202 to analysis function 216. In another alternative, medical file 204 may be provided to analysis function 216 directly by workflow manager 202 without being preprocessed.

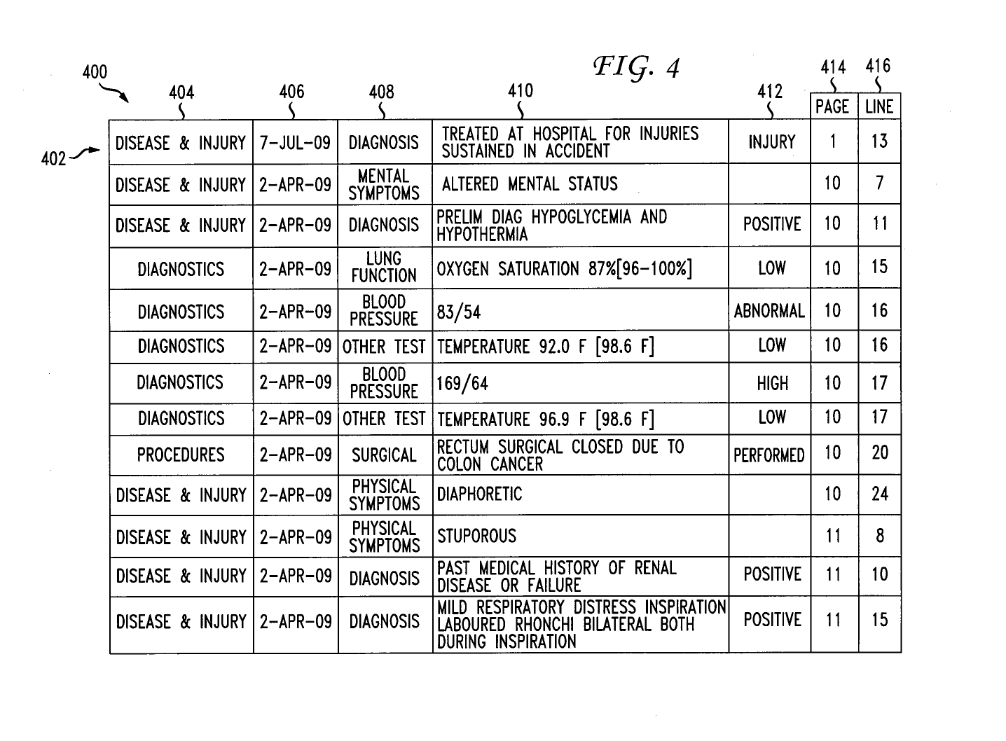

Analysis function 216 includes data-point analysis operations 218 for analyzing a medical file 204 based on one or more data-points to generate a data-point file. In one embodiment, a data-point is an extraction of particular data from a medical record in accordance with a specification. The format for data-points may be controlled for consistency, readability and relevancy to medical importance. One or more doctors, pharmacists, medical technologists or other trained medical professionals may perform data point analysis by manually or semi-automatically analyzing one or more data-points of a medical file 204 to generate a data-point file, as shown in FIG. 4. For example, data-point file 400 may be formatted to include one or more data points 402 containing columns for data point descriptions 404, dates-of-entry 406, subject matter 408 (e.g., diagnosis, test, procedure), actions performed/notations 410, assessments 412 and page 414 and line 416 numbers corresponding to the pages/lines containing the data point information in the original medical file 204.

In one embodiment, medical professionals may perform data point analysis on a medical file 204 at a remote location, such as at the pre-processing remote location or, alternatively, at another remote location relative to workflow manager 202. Additional personnel at the data point analysis remote location may perform quality assurance (QA) 220 on generated data-point files (e.g., by comparing data entries to machine made classifications of disease). For example, if a generated data point file does not comply with QA standards, the data point file may be returned for additional data point analysis or error correction at 222.

If the data point file is determined to comply with QA standards, the data point file is returned to workflow manager 202, which may provide the data point file for coding at coding function 224. For example, workflow manager 202 may provide the data point file to coding engine 226 for coding according to one or more medical record coding standards.

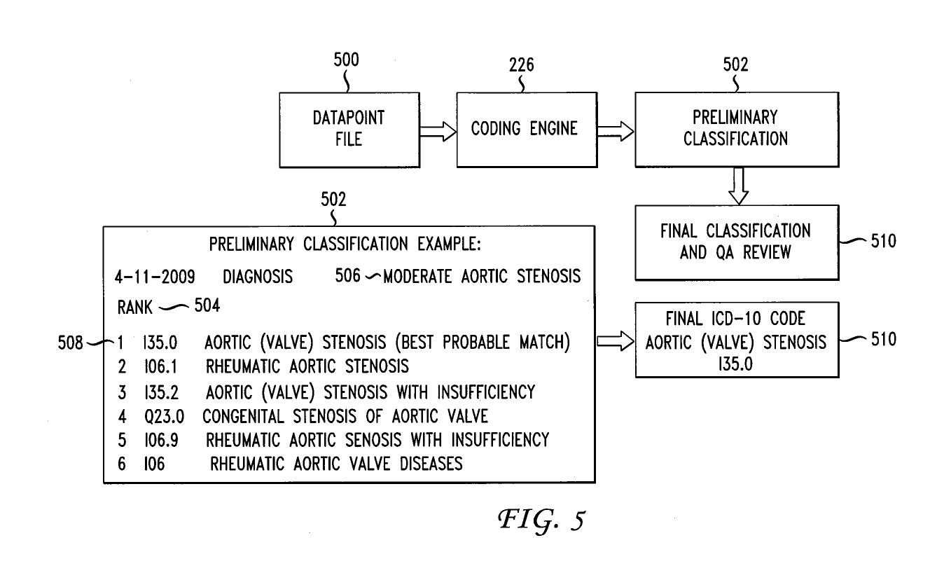

Coding engine 226 may be implemented via one or more devices external to workflow manager 202. As illustrated in FIG. 5, upon receiving a data-point file 500, coding engine 226 may be configured to automatically code a data point file (e.g., based on one or more medical record coding standards, such as MeSH, MIB, ICD-10, ICD-10-CM, etc., or synthetic codes) to generate a coded file.

For example, coding engine 226 may be configured analyze a data-point file to identify particular data points, such as data points that are undefined (e.g., data points that do not include a coded entry for a medical condition or diagnosis). Coding engine 226 then may employ search algorithms to determine codes for the particular data points. In one embodiment, coding engine 226 may employ one or more advanced analysis algorithms to determine a preliminary classification 502 (i.e., a probability ranking) of codes for particular data points based on data analysis (e.g., diagnosis correlation) criteria. For example, a preliminary classification 502 of a particular data point of a data-point file generated by coding engine 226 may include rankings of codes 504 that are probable matches for a given diagnosis 506, wherein the highest ranked code 508 may indicate the best probable match for the given diagnosis. The best probable match then may be included as a final classification 510 for the diagnosis 506 in a coded file.

In another embodiment, an advanced analysis algorithm may be based on the absolute semantic relevancy of two expressions. For example, an expression can be one or more words or symbols. Stored relevancy rules may then be accessed for processing a data-point. Completeness of the process may be expressed as a percentage and determined by how much of the expression to be processed can be understood based on the algorithm.

The context of the semantic relevancy assessment also may be taken into account. For diseases, the relevancy context may be semantic relevancy as to a normalized expression of the disease. For example, a relevancy scale of 0 (no relevancy), 1 (some relevancy depending on the use case), 2 (moderate relevancy) and 3 (generally always relevant) may be utilized to express semantic relevancy.

The context of the semantic relevancy may also be an attribute. For example, the context may be normalizing a disease classification into a codex (ICD-10-CM). In other systems, the attribute (context) may be different. This can be mathematically expressed as expression (Exp) A 3R Exp B (Z)—wherein Exp A has the highest degree of relevancy to Exp B in the context of attribute Z.

In yet another embodiment, an advanced analysis algorithm may be based on synthetic codes (also referred to herein as “synthetic medical condition codes”). Synthetic codes may be used, for example, when the existence of multiple variables (conditions) may collectively evince a high-risk or uninsurable condition. In one embodiment, a synthetic code may be represented by the expression, S=A+B+C+D . . . , where S represents a synthetic medical condition code which is true only if A, B, C, and D are true, and where A, B, C, and D represent various medical conditions, code values, pain scales, measurements or other variables. For example, a synthetic code representing an uninsurable coronary artery disease (UCAD) condition may be true if a variable A (representing the existence of coronary artery disease) is true, and if a variable B (representing severe blockage in one or more arteries) is true (i.e., UCAD=A+B). Patient-specific synthetic codes (e.g., combinations specific to a particular patient) may be stored and accessed for processing a data-point file.

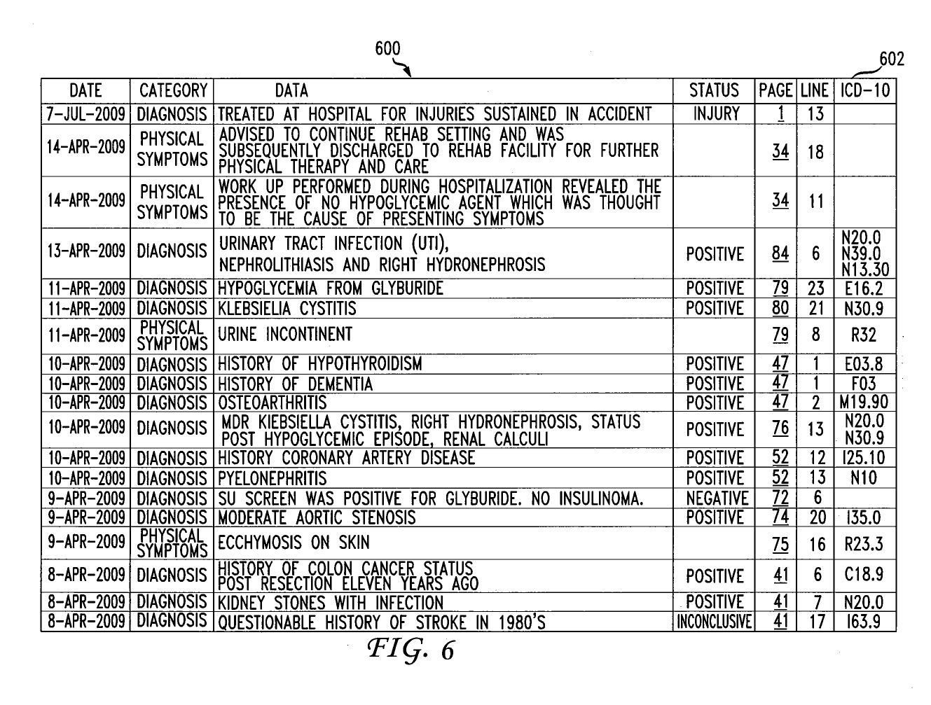

FIG. 6 illustrates a coded file wherein the data-points are coded according to one or more medical record coding standards. For example, coded file 600 may include a column 602 wherein one or more standard medical codes (such as MeSH, MIB, ICD-10 or ICD-10-CM codes) or synthetic codes are assigned to the data-points.

When a coded file is generated, workflow manager 202 provides the coded file to generate a medical report at normalization function 228. In one embodiment, normalization engine 230 is configured to format a coded file to a standard code of disease classification, e.g., ICD-10-CM, for an automated insurance underwriting process. For example, the final normalization may be to a symbolic code that represents the disease, such as the ICD-10-CM classification (Z88.0) for an allergy to penicillin. Alternatively, a coded file can be normalized, either automatically, semi-automatically or manually (e.g., by humans), to generate a medical report. In one embodiment, normalization engine 230 may generate feedback from normalization operations that can be used to generate or improve algorithms for coding engine 226 (e.g., to improve the automatic coding process).

Additional personnel may perform quality assurance (QA) 232 on a generated medical report. For example, if a medical report does not comply with QA standards after normalization, it may be returned for error correction at 234. If the medical report passes QA at 234, the medical report may be provided to an automated insurance underwriting process (e.g., implemented at insurance client server 238), such as via a secure client upload 236. For example, a medical report may be uploaded to an automated insurance underwriting process via network 206. Alternatively, a medical report may be uploaded to insurance client server 238 via a direct interface connection 240. In one embodiment, workflow manager 102 may receive a medical report generated by the normalization engine and may be configured to upload the medical report to insurance client server 238, store the medical report at database 103 or further process the medical report (e.g., to determine a correlation between the medical report and other medical or statistical data).

It should be noted that while the one or more steps for processing a medical file are described herein as being distinct processing steps, these divisions are included solely for the purposes of clarity and ease of understanding. Moreover, one skilled in the art will recognize that one or more of the various steps may be consolidated (e.g., into fewer steps) or expanded (e.g., to include one or more additional steps or sub-steps), and that the processing steps presented herein, while exemplary, are not intended to preclude other methods of implementation.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIGS. 1A and 2. Certain steps of the methods described herein, including one or more of the steps of FIGS. 1A and 2, may be performed by a server or by another processor in a network-based cloud-computing system. Certain steps of the methods described herein, including one or more of the steps of FIGS. 1A and 2, may be performed by a client computer in a network-based cloud computing system. The steps of the methods described herein, including one or more of the steps of FIGS. 1A and 2, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 1A and 2, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

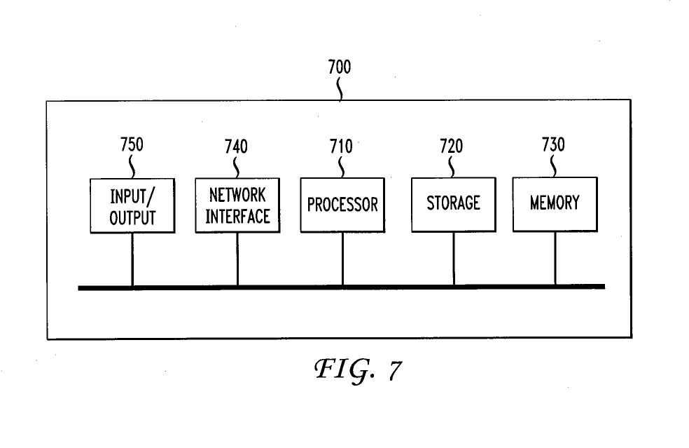

A high-level block diagram of an exemplary computer that may be used to implement systems, apparatus and methods described herein is illustrated in FIG. 7. Computer 700 comprises a processor 710 operatively coupled to a data storage device 720 and a memory 730. Processor 710 controls the overall operation of computer 700 by executing computer program instructions that define such operations. The computer program instructions may be stored in data storage device 720, or other computer readable medium, and loaded into memory 730 when execution of the computer program instructions is desired. Thus, the method steps of FIGS. 1A and 2 can be defined by the computer program instructions stored in memory 730 and/or data storage device 720 and controlled by processor 710 executing the computer program instructions. For example, the computer program instructions can be implemented as computer executable code programmed by one skilled in the art to perform an algorithm defined by the method steps of FIGS. 1A and 2. Accordingly, by executing the computer program instructions, the processor 710 executes an algorithm defined by the method steps of FIGS. 1A and 2. Computer 700 also includes one or more network interfaces 740 for communicating with other devices via a network. Computer 700 also includes one or more input/output devices 750 that enable user interaction with computer 700 (e.g., display, keyboard, mouse, speakers, buttons, etc.).

Processor 710 may include both general and special purpose microprocessors, and may be the sole processor or one of multiple processors of computer 700. Processor 710 may comprise one or more central processing units (CPUs), for example. Processor 310, data storage device 720, and/or memory 730 may include, be supplemented by, or incorporated in, one or more application-specific integrated circuits (ASICs) and/or one or more field programmable gate arrays (FPGAs).

Data storage device 720 and memory 730 each comprise a tangible non-transitory computer readable storage medium. Data storage device 720, and memory 730, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 750 may include peripherals, such as a printer, scanner, display screen, etc. For example, input/output devices 750 may include a display device such as a cathode ray tube (CRT), plasma or liquid crystal display (LCD) monitor for displaying information to the user, a keyboard, and a pointing device such as a mouse or a trackball by which the user can provide input to computer 700.

Any or all of the systems and apparatus discussed herein, including workflow manager 202, coding engine 226 and insurance client server 236 may be implemented using a computer such as computer 700.

One skilled in the art will recognize that an implementation of an actual computer or computer system may have other structures and may contain other components as well, and that FIG. 7 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for processing medical files comprising:
receiving a raw data electronic medical file;
performing data point analysis on the raw data electronic medical file to generate a data-point file;
algorithmically determining, by a processor, an insurability indication based on a plurality of identified medical variables related to the data-point file, wherein the plurality of identified medical variables collectively evince a risk-level associated with one or more medical conditions, and wherein the insurability indication is adapted for rendering an automatic insurability determination in an automated insurance underwriting process; and
automatically coding the data-point file to generate a coded file.

2. The method of claim 1 further comprising:
preprocessing the medical file prior to performing data-point analysis.

3. The method of claim 2 wherein preprocessing comprises removing non-relevant information from the medical file.

4. The method of claim 1 further comprising:
normalizing the coded file to generate a medical report.

5. The method of claim 4 wherein automatically coding is based at least in part on feedback from a prior normalization.

6. The method of claim 4 further comprising:
providing the medical report to an automated insurance underwriting process.

7. The method of claim 1 wherein performing data-point analysis is based on a predefined data-point specification.

8. The method of claim 1 wherein the data-point file comprises a plurality of data points and automatically coding the data-point file comprises:
assigning one or more MeSH, MIB, ICD-10, ICD-10-CM or synthetic codes to the data points.

9. The method of claim 1 wherein performing data-point analysis comprises identifying probable errors in the medical file.

10. The method of claim 1 further comprising:
providing the coded file to an automated insurance underwriting process.

11. The method of claim 10 further comprising:
determining a correlation between the coded file and mortality or life expectancy data; and
providing the correlation to the automated insurance underwriting process, wherein a life expectancy prediction is determinable based on the correlation.

12. The method of claim 1 further comprising:
generating a heat map of individual or group medical conditions, disease or symptoms based on a plurality of coded files; and
providing the heat map to the automated insurance underwriting process.

13. The method of claim 10 further comprising:
determining a correlation between the coded file and reported individual or group symptoms or medical test results; and
providing the correlation to the automated life insurance underwriting process, wherein a future disease trend is predictable based on the correlation.

14. An apparatus comprising:
a data storage device; and
a workflow manager communicatively coupled to the data storage device, the workflow manager in cooperation with the data storage device configured to:
provide a raw data electronic medical file to a data-point analysis function for data-point analysis;
receive a data-point file generated by the data-point analysis function and based on data point analysis of the raw data electronic medical file;
algorithmically determine an insurability indication based on a plurality of identified medical variables related to the data-point file, wherein the plurality of identified medical variables collectively evince a risk-level associated with one or more medical conditions, and wherein the insurability indication is adapted for rendering an automatic insurability determination in an automated insurance underwriting process;
provide the data-point file to a coding engine for automatic coding; and
receive a coded file generated by the coding engine and based on automatic coding of the data-point file.

15. The apparatus of claim 14 wherein the workflow manager is further configured to provide the medical file for preprocessing prior to providing the medical file to the data-point analysis function for data-point analysis.

16. The apparatus of claim 15 wherein preprocessing comprises removing non-relevant information from the medical file.

17. The apparatus of claim 14 wherein the workflow manager is further configured to:
provide the coded file to a normalization engine for normalization; and
receive a medical report generated by the normalization engine and based on normalization of the coded file.

18. The apparatus of claim 17 wherein automatically coding is based at least in part on feedback from a prior normalization of a coded file.

19. The apparatus of claim 17 wherein the workflow manager is further configured to provide the medical report to an automated insurance underwriting process.

20. The apparatus of claim 14 wherein the data-point analysis function generates the data-point file based on a predefined data-point specification.

21. The apparatus of claim 14 wherein the data-point file comprises a plurality of data points and the coding engine is configured to assign one or more MeSH, MIB, ICD-10, ICD-10-CM or synthetic codes to the data points.

22. The apparatus of claim 14 wherein the data-point analysis comprises identifying probable errors in the medical file.

23. The apparatus of claim 14 wherein the workflow manager is further configured to provide the coded file to an automated insurance underwriting process.

24. The apparatus of claim 23 wherein the workflow manager is further configured to:
determine a correlation between the coded file and mortality or life expectancy data; and
provide the correlation to the automated insurance underwriting process, wherein a life expectancy prediction is determinable based on the correlation.

25. The apparatus of claim 23 wherein the workflow manager is further configured to:
generate a heat map of individual or group medical conditions, disease or symptoms based on a plurality of coded files; and
provide the heat map to the automated insurance underwriting process.

26. The apparatus of claim 23 wherein the workflow manager is further configured to:
determine a correlation between the coded file and reported individual or group symptoms or medical test results; and
provide the correlation to the automated insurance underwriting process, wherein a future disease trend is predictable based on the correlation.

27. The method of claim 1 wherein the insurability indication is synthetic medical condition code.

28. The apparatus of claim 14 wherein the insurability indication is synthetic medical condition code.
